(19) United States
(12) Patent Application Publication
(10) Pub. No.: US 2016/0237735 A1
(43) Pub. Date: Aug. 18, 2016

(54) Foam Filled Frame Member

(71) Applicant: Architectural & Metal Systems Limited, County Cork (IE)

(72) Inventor: David Rawlings, Gloucestershire (GB)

(21) Appl. No.: 15/040,629

(22) Filed: Feb. 10, 2016

(30) Foreign Application Priority Data
Feb. 13, 2015 (GB) 1502484.7

(51) Int. Cl. E06B 1/32; E04B 1/76; E06B 7/16; E04B 1/68; E06B 1/36; E06B 1/52

(52) U.S. Cl. CPC E06B 1/32; E06B 1/36; E06B 1/52; E06B 7/16; E04B 1/6801; E04B 1/76

(57) ABSTRACT

A foam filled frame member comprises first and second frame components 12, 14 spaced apart from one another and connected to one another by a first bridge 20 and by a second bridge 22, the first and second frame components 12, 14 and first and second bridges 20, 22 together defining an elongate void, a foam material 26 located within the void and substantially filling the void, and a tie member 30 interconnecting the first and second bridges 20, 22 to restrain the first and second bridges 20, 22 against movement towards or away from one another.

This invention relates to a frame member, for example for use in the formation of window or door frames, the frame member defining a foam filled cavity. In particular, the invention relates to a frame member including at least one extruded metallic frame component, for example of extruded aluminium form.

Aluminium and other metallic materials have been used, for many years, in the manufacture of window and door frames. One disadvantage with the use of such materials is that they are of good thermal conductivity. Consequently, heat loss from a building including window or door frames of metallic form can be unacceptably high, and condensation tends to form on the window or door frames. In order to reduce these problems, it is known to manufacture frame members in such a manner as to include an inner frame component rigidly secured to, but spaced apart from, an outer frame component, the manner in which the frame components are interconnected being such as to provide a thermal break of good thermal insulting properties therebetween.

One known technique involves manufacturing the inner and outer frame components as a single unit that is shaped to define a channel, pouring a resin material into the channel and, once the resin has cured, machining away the metallic material originally interconnecting the inner and outer frame components to leave a frame member made of inner and outer frame components rigidly interconnected only by the resin material which provides the required thermal break between the inner and outer components.

Another known technique involves interconnecting the inner and outer frame components using components with relatively low thermal conductivity to define a void, and introducing a foaming material into the void to substantially fill the void.

In order to enhance the levels of thermal insulation that can be attained it is desirable to increase the distance by which the inner and outer frame components are spaced apart. Clearly, if the strength of the frame member is to be maintained, this can result in the arrangement by which the frame components are interconnected and by which the thermal break is provided being required to bear additional loadings.

It is an object of the invention to provide a frame member whereby the spacing of the frame components thereof can be increased.

According to the present invention there is provided a frame member comprising first and second frame components spaced apart from one another and connected to one another by a first bridge and by a second bridge, the first and second frame components and first and second bridges together defining an elongate void, a foam material located within the void and substantially filling the void, and a tie member interconnecting the first and second bridges to restrain the first and second bridges against movement towards or away from one another.

The tie member is conveniently provided with a series of openings through which the foam material extends such that the foam material extends continuously between the first and second frame components.

The first bridge conveniently comprises a plastics material component, conveniently of extruded form. The second bridge similarly conveniently comprises a plastics material component. Alternatively, the second bridge may take the form of one or more cured resin elements, cured in situ, providing a connection between the first and second frame components.

The first frame component may be of hollow form, and the foam material may extend continuously into the hollow of the first frame component.

The invention further relates to a method of manufacture of such a frame member.

The invention will further be described, by way of example, with reference to the accompanying drawings, in which:

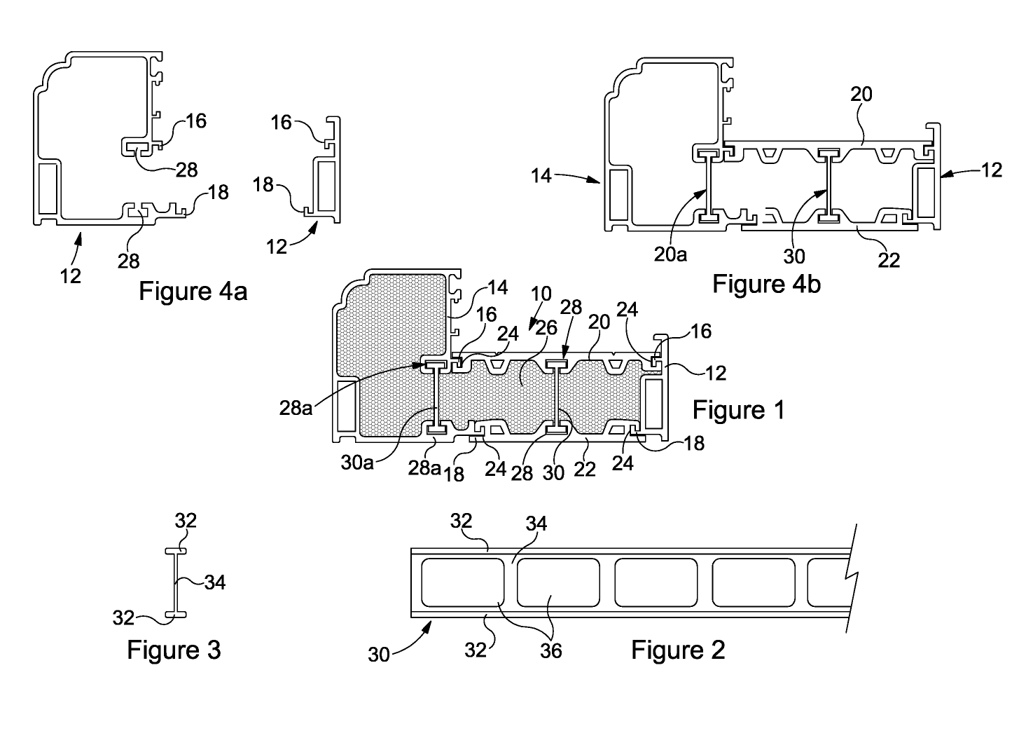

FIG. 1 is a view illustrating a frame member in accordance with one embodiment of the invention;

FIGS. 2 and 3 are views illustrating part of the frame member of FIG. 1;

FIGS. 4a and 4b illustrate stages in the process by which the frame member of FIG. 1 is manufactured; and

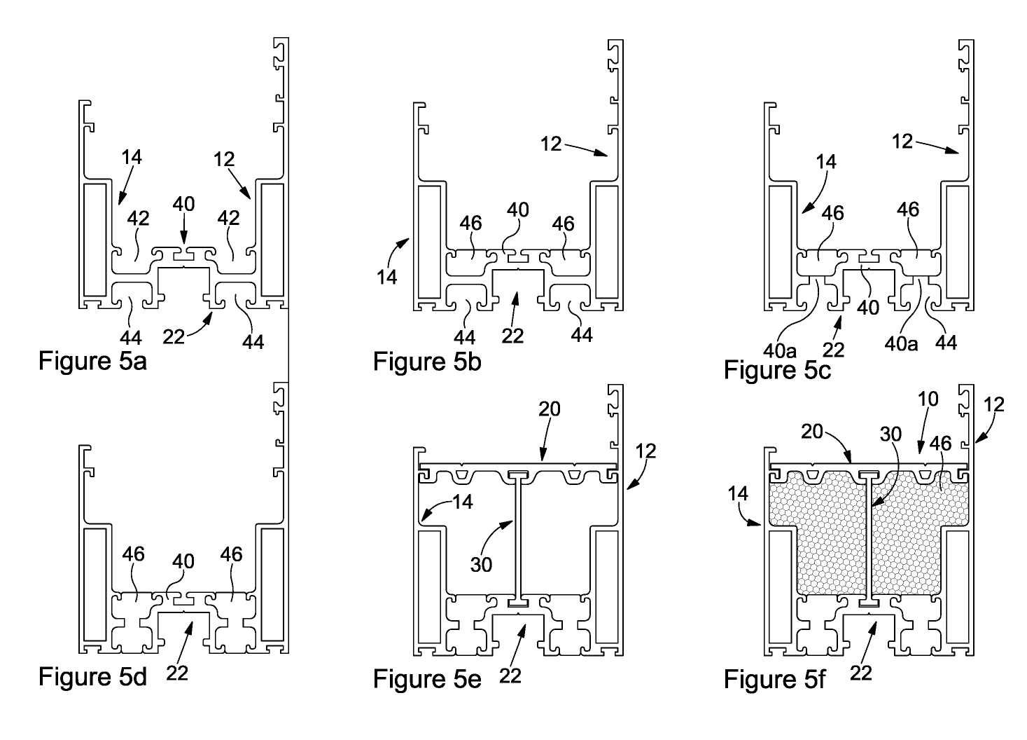

FIGS. 5a to 5f illustrate stages in the manufacturing process by which the frame member of a second embodiment of the invention may be manufactured.

Referring firstly to FIG. 1, an insulated frame member 10 for use in the manufacture of, for example, a window or door frame is illustrated. The frame member 10 comprises an inner frame component 12 of extruded aluminium form, and an outer frame component 14 also of extruded aluminium form. The inner and outer frame components 12, 14 each include first and second connection features 16, 18, in the form of generally L-shaped projections, whereby first and second bridges 20, 22 of extruded plastics material form are secured to the inner and outer frame components 12, 14. As illustrated, each of the bridges 20, 22 is provided, at the opposite edges thereof, with a generally L-shaped recess 24 adapted to receive respective ones of the connection features 16, 18.

It will be appreciated that with the inner and outer frame components 12, 14 interconnected by the first and second bridges 20, 22, an elongate void is formed therebetween which, as illustrated, is filled with a foamed material 26.

As shown in FIG. 1, adjacent its midpoint each of the bridges 20, 22 is provided with a re-entrant recess 28, the recesses 28 being aligned with one another and receiving respective end parts of a generally I-shaped tie member 30. As shown in FIGS. 2 and 3, the tie member 30 comprises upper and lower flanges 32 that, in use, are received within the recesses 28, the flanges 32 being interconnected by a web 34 that is formed with a series of openings 36.

As shown in FIG. 1, the outer frame component 14 is provided with a similar pair of aligned recesses 28a, a similar tie member 30a being associated therewith.

During assembly or manufacture, as illustrated in FIGS. 4a and 4b, the inner and outer frame components 12, 14 are interconnected by the first and second bridges 20, 22, this conveniently being achieved by engaging end parts of the features 16, 18 in end parts of the recesses 24, and sliding the bridges 20, 22 in the axial direction relative to the frame components 12, 14. The tie members 30, 30a are similarly fitted in position by axial sliding. Once the frame components 12, 14, bridges 20, 22 and tie members 30, 30a have been assembled as shown in FIG. 4b, a foaming material is introduced into the void 26 defined between the frame components 12, 14 and the bridges 20, 22, the foaming material foaming and expanding to fill the void 26. It will be appreciate that during foaming the material 26 is able to pass through the openings 36 provided in the tie members 30, 30a. Accordingly, in the finished product as shown in FIG. 1 the foam material 26 extends continuously from the inner frame component 12 to the outer frame component 14. Furthermore, in this embodiment, the foam material extends continuously through the tie member 30a into the outer frame component 14, filling or substantially filling a void of hollow formed therein.

During foaming of the foam material 26, it will be appreciated that significant loadings are applied to the bridges 20, 22 urging them apart. However, the presence of the tie member 30 serves to resist such movement, thereby ensuring that the final product is of the desired shape and that bowing or other deformation of the bridges 20, 22 is avoided. Likewise, the presence of the tie 30a serves to resist deformation of the outer frame component 14 that could otherwise occur during foaming of the material located therein.

It will be appreciated that by providing the tie member 30 between the bridges 20, 22, and thereby resisting bowing or other deformation thereof, the distance by which the inner and outer frame components 12, 14 are separated can be increased leading to an enhancement in the thermal insulating properties of the frame member 10 without resulting in deformation of the product.

Whilst the description hereinbefore relates to an arrangement in which both of the bridges 20, 22 take the form of extruded plastics material components or the like, the invention is not restricted in this regard. FIGS. 5a to 5f illustrate an arrangement in which the first bridge 20 is of this form, but in which the second bridge 22 is manufactured using a so-called pour-and-cut method. In this arrangement, as illustrated in FIG. 5a, the inner and outer frame components 12, 14 are manufactured integrally with one another, the inner and outer frame components 12, 14 being interconnected by an integral bridge part 40. The bridge part 40, together with the inner and outer frame components 12, 14, define upper and lower pairs of channels 42, 44. The channels 42, 44 are each shaped to include lips or projections arranged, in use, to interact or interlock with a resin material.

As shown in FIG. 5b, during the manufacturing process, a curable resin material 46 is poured into the upper pair of channels 42 and is allowed to cure. After curing, the regions 40a of the bridge part 40 defining the bases of the channels 42 are machined away, as shown in FIG. 5c. It will be appreciated that at this point, the inner and outer frame components 12, 14 are interconnected only by the remaining central region of the bridge part 40 and by the cured resin material 46 in the channels 42. Subsequently, as shown in FIG. 5d, additional resin material 46 is applied to fill the channels 44, and this resin material 46 is allowed to cure.

Subsequently, a first bridge 20 is slid into position, interconnecting the inner and outer frame components 12, 14 in much the same manner as the first bridge 20 of the embodiment shown in FIGS. 1 to 4. A tie member 30 of the same general form as that of the embodiment of FIGS. 1 to 4 is used to interconnect the first bridge 20 and the bridge part 40 forming part of the second bridge 22. It will be appreciated that in this condition a void is defined between the inner and outer frame components 12, 14 and the first and second bridges 20, 22, to which a foaming material is applied such that, once foamed, the void will be substantially filled with foam material 26.

In both of the embodiments described hereinbefore, once foamed, the foam material 26 serves to tightly lock the component parts of the frame member 10 to one another, the tie members 30 serving to restrain at least the first bridge 20 against bowing or deformation. Accordingly, the inner and outer frame components 12, 14 can be spaced apart by a relatively great distance. By arranging for at least one of the frame components 12, 14 to include a void (as in the embodiment of FIGS. 1 to 4) the foam material 26 can extend continuously into that frame component 12, 14, further enhancing the strength and the thermal insulating properties of the frame member. By using a pour-and-cut method in the formation of one of the bridges, as in the embodiment of FIG. 5, the physical strength, as well as the thermal insulating properties, of the frame member can be enhanced.

Whilst the description hereinbefore relates to two specific embodiments, it will be appreciated that a wide range of modifications and alterations may be made or incorporated without departing from the scope of the invention as defined by the appended claims.

1. A foam filled frame member comprising first and second frame components spaced apart from one another and connected to one another by a first bridge and by a second bridge, the first and second frame components and first and second bridges together defining an elongate void, a foam material located within the void and substantially filling the void, and a tie member interconnecting the first and second bridges to restrain the first and second bridges against movement towards or away from one another.

2. A frame member according to claim 1, wherein the tie member is provided with a series of openings through which the foam material extends such that the foam material extends continuously between the first and second frame components.

3. A frame member according to claim 1, wherein the first bridge comprises a plastics material component.

4. A frame member according to claim 3, wherein the first bridge is of extruded form.

5. A frame member according to claim 1, wherein the second bridge comprises a plastics material component.

6. A frame member according to claim 5, wherein the second bridge is of extruded form.

7. A frame member according to claim 1, wherein the second bridge comprises one or more cured resin elements, cured in situ, providing a connection between the first and second frame components.

8. A frame member according to claim 1, wherein the first frame component is of hollow form, the foam material extending continuously into the hollow of the first frame component.

9. A frame member according to claim 8, wherein the first frame component has a tie member connected thereto.

10. A method of manufacture of a frame member comprising providing first and second frame components spaced apart from one another and connected to one another by a first bridge and by a second bridge, the first and second frame components and first and second bridges together defining an elongate void, providing a tie member interconnecting the first and second bridges to restrain the first and second bridges against movement towards or away from one another, and providing a foaming material in the void, allowing the foaming material to foam to substantially fill the void.

11. A method according to claim 10, wherein the tie member is provided with a series of openings through which the foam material extends such that the foam material extends continuously between the first and second frame components.

12. A method according to claim 10, wherein the first frame component is of hollow form, the foam material extending continuously into the hollow of the first frame component.

13. A method according to claim 12, wherein the first frame component has a second tie member connected thereto.
